(19) United States
(12) Patent Application Publication
(10) Pub. No.: US 2015/0205271 A1
(43) Pub. Date: Jul. 23, 2015

(54) AUTOMATED RECONFIGURATION OF A DISCRETE EVENT CONTROL LOOP

(71) Applicant: Siemens Aktiengesellschaft, Muenchen (DE)

(72) Inventors: Jan Richter, Lauf a.d. Pegnitz (DE); Thomas Moor, Muehlhausen (DE); Thomas Wittmann, Erlangen (DE)

(21) Appl. No.: 14/415,426

(22) PCT Filed: Jul. 1, 2013
(86) PCT No.: PCT/EP2013/063783

§ 371 Date: Jan. 16, 2015

(30) Foreign Application Priority Data
Jul. 17, 2012 (EP) 12176671.1

(51) Int. Cl. G05B 13/04

(52) U.S. Cl. CPC G05B 13/04

(57) ABSTRACT

The method and the apparatus are concerned exclusively with dynamic processes that can be represented dominantly by discrete-event processes and for the dynamics of which it is not the time but rather the logical order of the symbols that is critical.

The method and the apparatus cater to the specifics of discrete-event problems.

The technical apparatus for designing and realizing automated reactions to the failure of actuators and sensors in discrete automation-engineering installations ensures that the effects of said failures on the process remain at a minimum, and also a method that allows said faults to be systematically integrated into discrete-event models in order to take this as a basis for carrying out formal design of fault-tolerant discrete-event controllers.

### REFERENCE TO RELATED APPLICATIONS

This is a U.S. national stage of application No. PCT/EP2013/063783 filed 1 Jul. 2013. Priority is claimed on European Application No. 12176671.1 filed 17 Jul. 2012, the content of which is incorporated herein by reference in its entirety.

### BACKGROUND OF THE INVENTION

1. Field of the Invention

The invention relates to a method and an apparatus for automated design of a discrete-event control loop for regulating a technical process.

2. Description of the Related Art

Technical installations, particularly those for realizing discrete production processes (also discrete-event processes) are subject to faults or failures in their components, such as actuators or sensors. Faults cannot be ruled out in principle, i.e., in order to maintain operation it is necessary to react to faults in a suitable manner. This problem relates particularly to technical installations in which functioning (programmable) controllers in the form of closed control loops are essential to correct operation.

Failures in actuators and sensors open the control loop and terminate the demand-compliant operation of the installation. Other faults in these components, such as degradation, frequently alter control loop behavior in a disadvantageous manner. These phenomena reduce the availability and reliability of the installation and lead to financial losses and to damage to goods or people. Conventionally, the problem is overcome by replacing defective components.

Faults preferably mean failures in or degradation of critical components. Unforeseeable faults are excluded from further considerations.

In addition, regulation covers not only regulation in the strict sense of regulation via a closed control loop with return of an output variable to an input of a regulator but rather, this term is also extended to control in an open chain of action (without feedback). Accordingly, the terms control loops, regulators and control sections also each cover open chains of action, controllers and open-loop control sections.

The problem described is frequently countered by hardware redundancy. This involves the installation of multiple instances of critically important hardware components (actuators, sensors) prior to start up of the installation. Some of the components are used during normal operation and monitored continuously, the other components remaining on standby. If the monitoring indicates failure of a component, simple decision logic is taken as a basis for changing over to a substitute component. The method is suitable for handling early failures, random failures and fatigue failures in equal measure. It is used particularly in safety-critical applications, such as in nuclear engineering or in aviation.

The problem can also be overcome by providing voting schemes or diversity, and through the use of substitute fixed values.

The cited solutions involve high additional installation costs on account of the installation of multiple instances of components. Automated solutions that go beyond programmed special solutions are hitherto unknown for discrete-event processes.

When faults occur that open the control loop, (limited) operation is usually stopped and repair measures are initiated.

In industrial practice, the measures applied hitherto have been the following approaches, in particular:

### 1) Bank of Controllers:

For a finite number of fault situations considered prior to start up, dedicated controllers are designed offline and manually, between which it is then possible to change over online. The method is suitable for handling early failures, random failures and fatigue failures in equal measure.

This solution has the disadvantage that there is no evidence of the correctness of the manually programmed controllers and hence unsuitable fault reactions are possible. For the discrete-event processes considered below, another problem arises: the correct initialization of the regulator adopted in the changeover requires knowledge of the process state and of the failed regulator at the instant of the fault. This information is frequently not immediately known, which makes it much more difficult in practice to implement a bank of controllers for discrete-event processes.

### 2) Hardware Redundancy and Hardware Diversity:

Critically important hardware components (e.g., actuators, sensors) have multiple instances installed prior to start up of the installation, so that only some of the components are necessary to fulfill the purpose. By way of example, in the case of controllers with high availability, one of the controllers is used in normal operation and continuously monitored, and the redundant controller is kept in sync and assumes the role of the main controller in the event of failure of the main controller. This class of method is suitable for handling early failures, random failures and fatigue failures in equal measure. However, it involves additional installation costs on account of the multiple installation of physical components, such as actuators or sensors. Diversity, physical redundancy and voting are used primarily in safety-critical applications, such as in nuclear engineering or in aviation.

DE 198 57 894 discloses a system that has means for function monitoring, fault detection and location and resultant reconfiguration. In this case, the faults that occur are detected in real time during operation of the appliance. The software is then reconfigured at runtime.

WO2013/017168 discloses a method and an apparatus for automatic reconfiguration of a control loop for regulating a technical process, where during the runtime phase an ascertained fault prompts the control loop to be automatically reconfigured base on a mathematical model in which signals interchanged between the regulator and the control section are modified based on the fault.

### SUMMARY OF THE INVENTION

In view of the foregoing, it is an object of the invention to provide an improved method and an improved apparatus for automated reconfiguration of a control loop for regulating a technical process.

This and other objects and advantages are achieved in accordance with the invention by a method, an apparatus, and a computer program product, where the method in accordance with the invention is used for automated reconfiguration of the control loop having a control section having physically and/or analytically redundant components and a fault diagnosis unit for regulating a technical process.

In a first step, in the design phase a first mathematical model of the nominal control section and of nominal dynamics of the process is created on the assumption of fault-free behavior by the control loop by virtue of first model elements that can be taken from a model, library being connected up and parameterized.

In a second step in the control loop, any faults occurring and the effects of the faults are defined.

The mathematical model and the associated fault definitions are then used to produce an integrated model of the control loop that also contains faulty behavior by the control loop.

A nominal control section is understood to mean a control section in a fault-free state. Accordingly, nominal dynamics of a process are understood to mean fault-free execution of the process. Reconfiguration of a control loop is understood to mean a reaction to malfunctions in components of the control section of the control loop that counteracts the malfunctions, so that the effects of the malfunctions on the process regulated via the control loop are reduced. Components of the control section in this case are actuators and sensors, in particular.

Physically redundant components are understood to mean multiple installations of identical components that can replace one another, such as two identical hydraulic actuators for moving the rudder of a ship. Analytically redundant components are understood to mean components that, although physically different, can be used to attain the same type of action for at least one function. By way of example, a yaw moment of a ship can be produced firstly via a rudder and secondly via two drives of the ship that are offset from one another along a transverse axis of the ship, as a result of which the rudder and the two drives of the ship are analytically redundant components for production of the yaw moment.

The control section is an automation engineering installation having components that comprises actuators and sensors realized in physically and/or analytically redundant form in the control loop. The fault diagnosis unit can be used to ascertain and locate faults in these components, as a result of which faulty components of the control section can be ascertained via the fault diagnosis unit.

In a first embodiment, the first mathematical model is produced automatically from pre-existing engineering data from other design systems.

In a further advantageous embodiment, the integrated model is produced by additionally taking into account demands on the control section and ascertaining a control algorithm that can be executed in a runtime environment. Demands are statements about a property that needs to be implemented for the closed control loop.

It is also advantageous if the control algorithm is optimized by syntactic transformations prior to execution.

By way of example, the model and the integrated model can be defined by an automaton, a Petri net or by process algebraic expressions. The term process algebra (or process calculus) covers a large family of approaches to formal modeling of concurrent systems.

Process algebra allows the abstract description of interaction, communication and synchronization between a group of independent agents or processes. Algebraic laws allow the analysis or transformation of process descriptions. Examples of process algebra are CSP, CCS, ACP or Pi calculus.

In addition, the mathematical model in one embodiment of the nominal control section can be produced from further information about at least second elements that can be input via an interface.

The method claimed below and the apparatus are concerned exclusively with dynamic processes that can be represented dominantly by discrete-event processes, e.g., by symbol sequences, and for the dynamics of which it is not the time but, rather, the logical order of the symbols that is critical. Time-driven dynamic processes are executed in a manner concealed in hierarchically subordinate processes. The specific properties thereof are irrelevant to the way in which the object is achieved. The method and the apparatus cater to the specifics of discrete-event problems.

The technical apparatus for designing and realizing automated reactions to the failure of actuators and sensors in discrete automation-engineering installations ensures that the effects of the failures on the process remain at a minimum, and also ensure a method that allows the faults to be systematically integrated into discrete-event models in take this as a basis for carrying out formal design of fault-tolerant discrete-event controllers.

The method used in the tool contains no kind of restriction in respect of faults that can be handled so long as they are faults that can be represented in the relevant system class (e.g., automaton, Petri net, process algebra).

The fault situations to be covered need to be the subject of forward planning and modeled. The associated control logic for fault-tolerant operation is then created from the model automatically and translated into runtime code.

The method for fault modeling (fault-accommodating model) is combined with established control synthesis methods for discrete-event controllers in a manner that allows non-blocking and demand-compliant operation of the process following faults.

The method in accordance with the invention overcomes the difficulty that in the event of explicit changeover of the control program the discrete initial state is unknown. This problem is characteristic of discrete-event processes and does not arise in the case of continuous dominated dynamic systems, or can be overcome in the case of these.

The synthetically designed control algorithm is always correct by construction. Programming errors are precluded.

The method described and the apparatus additionally allow appropriate solutions to be found even if competing methods based on diagnosability terms (according to Sampath, Lafortune “Diagnosability of Discrete-Event Systems”, IEEE Transactions on Automation Control, vol. 40, no. 9, September 1995) fail.

The method refers to formal code synthesis, a future process model that is to be established for the creation of control programs for discrete-event systems.

Definition of the fault-accommodating model:
L_{FA} fault-accommodating model
L_{N} model of the fault-free behavior
F fault event
L_{D} model of the faulty behavior
Σ alphabet of the discrete-event system, including fault event

In that case, the fault-accommodating model is determined as follows:

L_{FA}=L_{N}∪(L_{N}^{F}Σ*∩L_{D})

Based on this model, an established synthesis method is performed.

In one advantageous embodiment, forms/solution templates are provided for frequently arising tasks in production engineering.

In a further advantageous embodiment, the library can be augmented with dedicated behavior models via an external interface.

A detailed description and explanation of the mathematical principles can be found in the publication by Thomas Wittmann, Jan Richter and Thomas Moor, “Fault-Tolerant Control of Discrete Event Systems based on Fault-Accommodating Models”.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The properties, features and advantages of this invention that are described above and also the manner in which they are achieved will become even more comprehensible in connection with the description of the drawings that follows, in which:

FIG. 1 shows a diagram of the method in accordance with the invention;

FIG. 2 shows the workflow in accordance with the invention for reconfigurating the system;

FIGS. 3 to 15 show conventional workflows as described in the publication “Fault-Tolerant Control of Discrete Event Systems based on Fault-Accommodating Models by Jan Richter and Thomas Moor; and

FIG. 16 is a flowchart of the method in accordance with the invention.

### DETAILED DESCRIPTION OF THE EXEMPLARY EMBODIMENTS

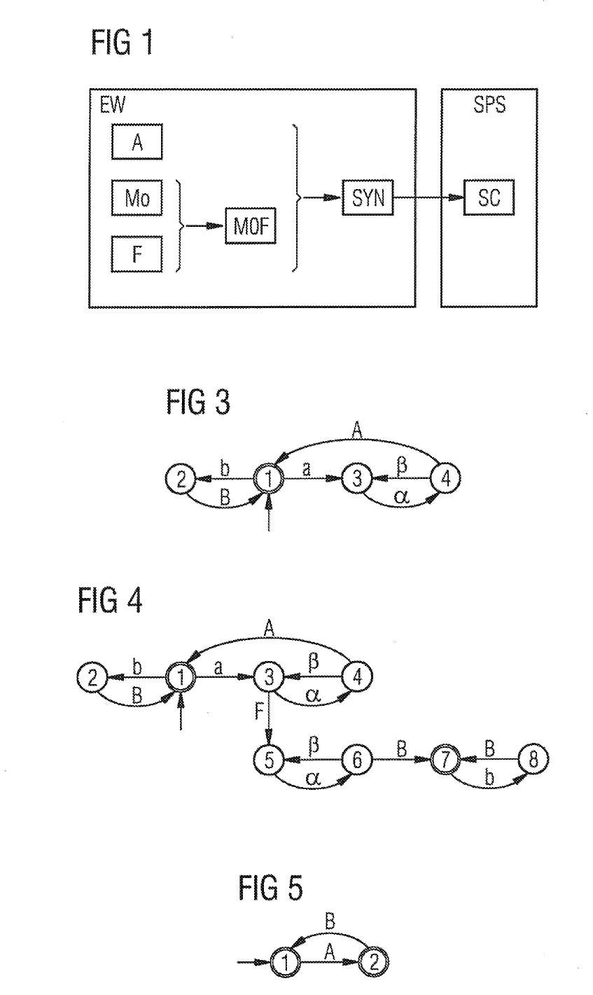

FIG. 1 shows the functionality of the tool EW, where the functionality is divided into two phases. In a design phase, the tool provides support on a PC basis for the design of the reconfiguration system using the functions described further below. The result of the design phase is then converted into a real-time-compatible control code SC code by the tool in an automated manner, the control code being used on a hardware component, such as an industrial controller PLC, an industrial PC or the PC of the control system.

The aim of the design phase is to model the installation in the fault-free case M0, and in the event of a fault F, and also the design of a fault-tolerant control algorithm.

The model MO created for the automation-engineering installation initially models the fault-free behavior of the installation. By way of example, the model can take on the guise of an automaton, a Petri net or process algebraic expressions. In an advantageous embodiment of the invention, the tool generates this model automatically using already existing engineering data from other design systems (e.g., from other CAE tools).

The significance and action of the possible faults F are modeled explicitly below.

In the next step, a single integrated model is produced from these for the specifications, where the model contains the fault-free response, the fault transition and the response of the process with the fault.

Based on the integrated model and prescribed demands A and also based on known formal methods, a control algorithm S is ascertained that ensures that the controlled process meets the demands A. The algorithm SC is then executed on a runtime environment (e.g., a programmable logic controller PLC). Optionally, there may be further purely syntactic transformations (“code generators”) between the synthesis result and the execution of the algorithm.

In the runtime phase, the control algorithm SC is processed.

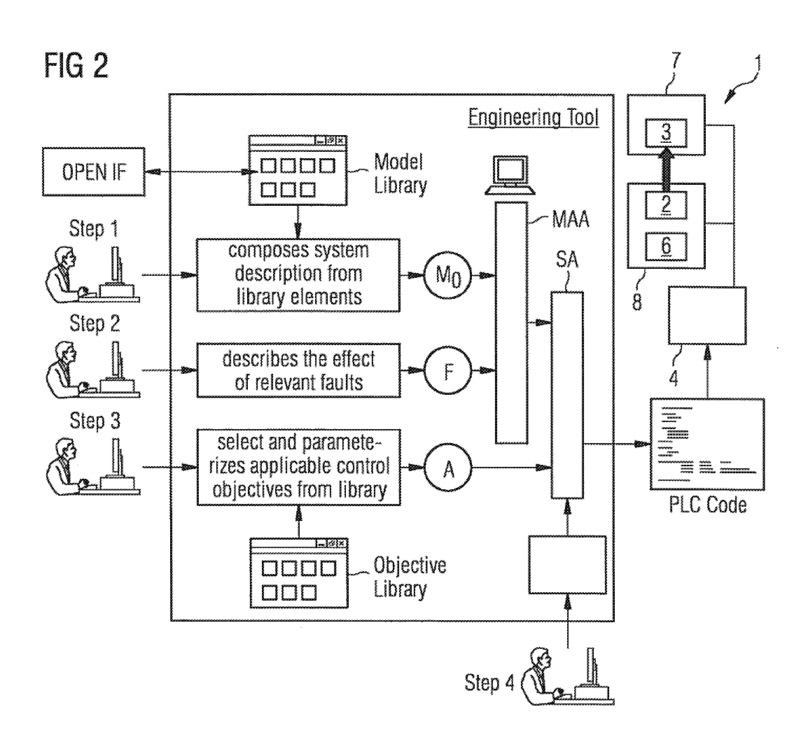

FIG. 2 shows the various phases of the operator control of an engineering system, Engineering Tool.

The first step Step1 describes a process based on provided model elements from a library, Model Library, which are connected up and parameterized, MAA. A model element is then a model of a subsystem of the installation. The library provides templates for models of frequently arising subsystems (e.g., conveyor belts, optical sensors or switches, singularizers). Every single template is a parameterizable model. All the templates together make up the library. A library typically relates to a specific application domain (e.g., packaging, bottle filling, pressing or automobile production). The term solution is intended to clarify the domain reference because the library (besides the methods) is the essence of the solution for a domain/sector.

The model elements are based on what are known as “Solution Templates”. The library may contain an open interface Open IF for incorporating further library elements of further models from third-party manufacturers.

The second step Step2 describes the effects of the faults on the system using the library elements.

The third step Step3 describes the demands, possibly by selecting typical demands, that are provided from a library Objective Library (likewise part of the “Solution Template”).

Steps 1 to 3 can each be performed with tool support.

The fourth step calls a synthesis algorithm SA. This is provided with the finished PLC code, which is syntactically and semantically correct by construction and can also be loaded directly into the PLC if required.

There follows a brief illustration of how an integrated model can be produced in practice.

FIGS. 3 to 15 show behavior models for an installation in the form of Petri nets, with the states 1 to 4 in FIG. 3, state 1 being the starting state.

Process A runs in state 3,

Process B in the state transition from 2 to 1.

Event a corresponds to “Start of Process A” and Event b corresponds to the “Start of Process B”.

a corresponds to “Start of subordinate process” and β corresponds to “end of subordinate process”.

FIG. 4 shows the sequence of the model from FIG. 3 with additional faults. The malfunctions are modeled as separate events 5 to 6. A distinction is subsequently drawn only between sequences without and sequences with faults. FIGS. 7 and 8 show an admissible fault-free behavior and an admissible faulty behavior, F being the fault transition.

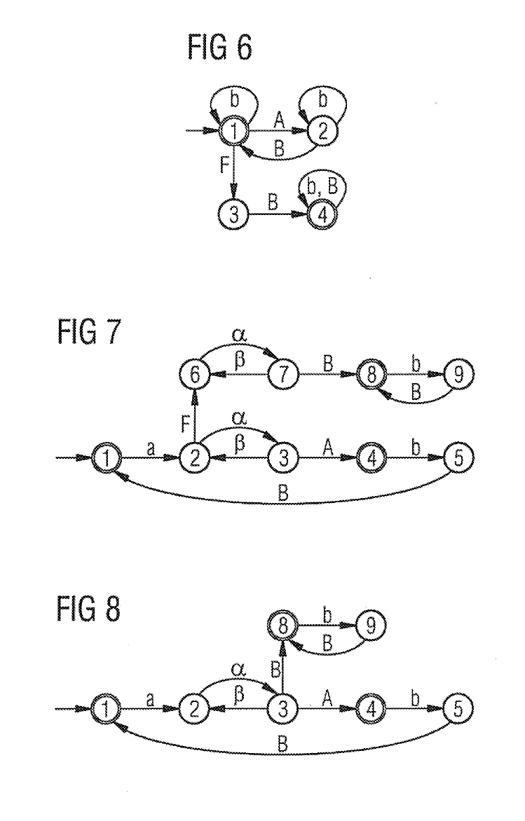

Standard algorithms (cf. Yoo and Garcia, “Diagnosis of behaviors of interest in partially-observed discrete-event systems” Systems and Control Letters, 57(12): 1023-1029, 2008, for example) are used to transform the models, and the result is shown in FIGS. 5 and 6.

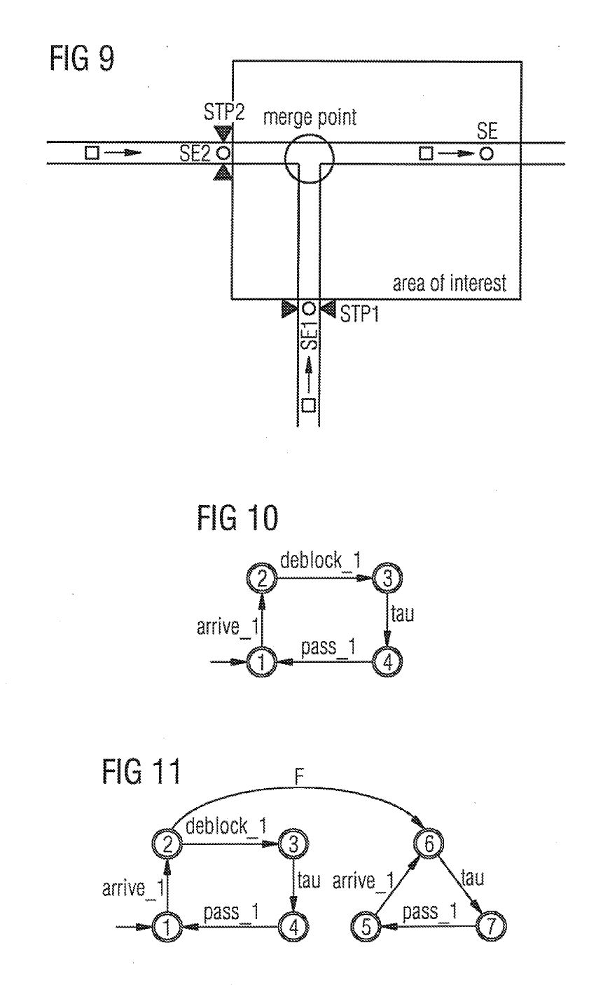

A more specific example is shown in FIG. 9. A frequently arising event is the collision-free control of a transport system (e.g., a conveyor belt). It is assumed that conveyor belts adopt a fixed speed. In addition, it is assumed that it is not possible for the conveyor belt to change direction. The conveyor belts meet at a junction and contain two stopper elements STP1 and STP2, each equipped with a sensor SE1 and SE2. The stoppers are responsible for the flow of workpieces allowing each one to be handled separately. A further sensor is mounted behind the point at which the two conveyor belts meet. Further assumptions are: there are redundant timers and the distance from STP2 to the junction is assumed to be shorter than the distance from STP1 to the junction. System information can be gathered from the statuses of the sensors. As soon as a workpiece reaches the marked area, controller actions no longer have any effects on the movement, and therefore the main task of the controller is coordination of the entry of the workpiece into the marked area.

It is additionally assumed that a fault occurs only in stopper element STP1. When a fault occurs, STP1 remains in an open position, and STP1 is no longer available for active control but can continue to be used for data collection.

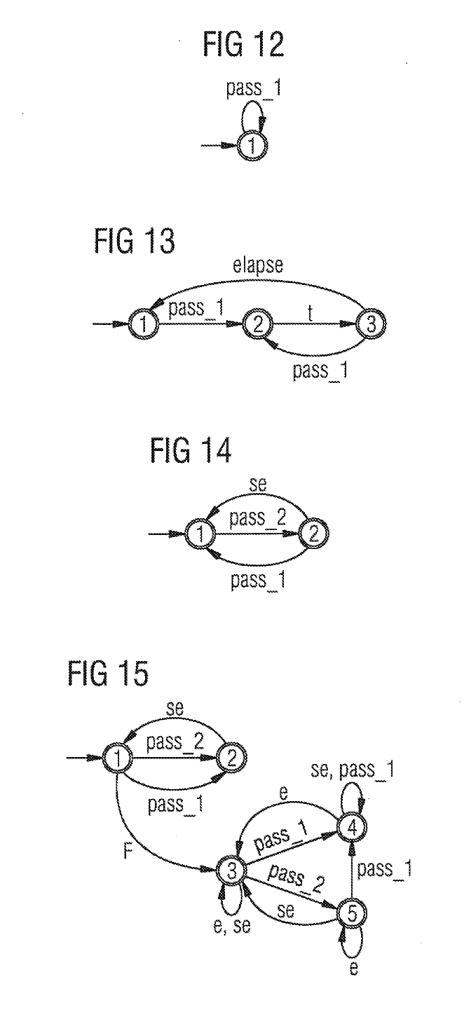

FIG. 10 shows a mathematical model of a stopper element. Following recognition of a workpiece, the stopper can block the workpiece or allow it to pass (deblock), and can wait a particular time (tau) after the workpiece has been allowed to pass (pass). Following the occurrence of a fault F, faulty possible behavior by the stopper element is shown in FIG. 11.

FIG. 12 shows a mathematical model for a sensor and FIG. 13 shows a model for a timer.

The behavior is summarized in the table below:

| Event | Interpretation | Attribute |
|---|---|---|
| arrive | Workpiece detected at the stopper | C, O |
| deblock | Stopper performs open cycle | C, O |
| pass | Workpiece passes through stopper | O |
| tau | Timer | C, O, F |
| t | Start Timer | O |
| e | Timer expires | O |
| sc | Workpiece detected at the sensor SE | O |
| F | Fault | |

FIG. 14 shows the mathematical model for the safety specification. As soon as the stopper STP1 is faulty, the requisite safety standards are no longer met and the specification needs to be changed to limit the effects of the fault. The stopper STP2 is closer to the junction than STP1. As result, collisions can be avoided by retaining all workpieces at STP2 at least for the period that a workpiece requires in order to be transported from STP1 to the junction. The representation of this process can be seen in FIG. 15. The brief summary and the small example reveal how the design of an installation in the form of mathematical models works. All provisions can be recorded and processed further as in the exemplary manner.

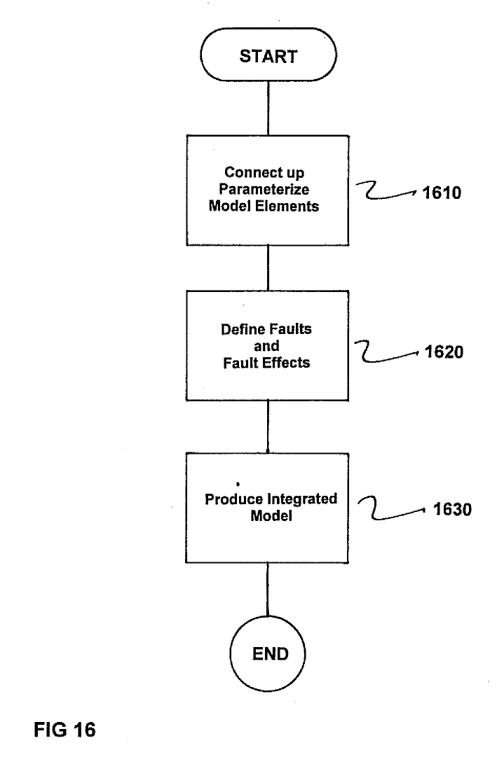

FIG. 16 is a flowchart of a method for automated design of a control loop (1) for regulating a technical process, where the control loop (1) includes a control section (4) having physically and/or analytically redundant components and having a fault diagnosis unit, and where during a design phase a first mathematical model (M0) of the nominal control section (4) and nominal dynamics of the process is created based on an assumption of fault-free behavior by the control loop in a design phase.

The method comprises connecting up and parameterizing first model elements of a model library, as indicated in step 1610.

Next, defining any faults (F) and the effects of those faults occurring in the nominal control section are defined, as indicated in step 1620.

An integrated model (M0F) of a control loop that contains both fault-free and faulty behavior by the control loop is now produced based on the mathematical model (M0) and associated fault definitions (F), as indicated in step 1630.

The procedure described above is intended to be understood merely by way of example and is not intended to restrict the scope of protection of the application.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-13. (canceled)

14. A method for automated design of a control loop for regulating a technical process, the control loop including a control section having at least one of physically and analytically redundant components and having a fault diagnosis unit, and in a design phase a first mathematical model of the nominal control section and nominal dynamics of the process being created based on an assumption of fault-free behavior by the control loop in a design phase, the method comprising:
connecting up and parameterizing first model elements of a model library;
defining any faults and effects of said faults occurring in the nominal control section; and
producing, based on the mathematical model and associated fault definitions, an integrated model of a control loop that contains both fault-free and faulty behavior by the control loop.

15. The method as claimed in patent claim 14, wherein the first mathematical model is produced automatically from already existing engineering data obtained from other design systems.

16. The method as claimed in claim 14, wherein the integrated model is produced by additionally taking into account demands on the control section and ascertaining a control algorithm that can be executed in a runtime environment.

17. The method as claimed in claim 15, wherein the integrated model is produced by additionally taking into account demands on the control section and ascertaining a control algorithm that can be executed in a runtime environment.

18. The method as claimed in claim 14, wherein the control algorithm is optimized by syntactic transformations prior to execution.

19. The method as claimed in claim 14, wherein the mathematical model and the integrated model are defined by one of (i) an automaton, (ii) a Petri net and (iii) process algebraic expressions.

20. The method as claimed in claim 14, wherein the mathematical model of the nominal control section is produced from further information about at least second elements that are can be input via an interface.

21. An apparatus for automated design of a control loop for regulating a technical process, the apparatus comprising:
a design component comprising:
means for creating a first mathematical model of the nominal control section and nominal dynamics of the process based on an assumption of fault-free behavior by the control loop;
means for defining faults and effects of said faults on the execution of the technical process occurring in the control section, and
means for producing an integrated model of the control loop from the mathematical model and the associated fault definitions, the integrated model also containing faulty behavior by the control loop.

22. The apparatus as claimed in patent claim 21, wherein the means for producing the first mathematical model use already existing engineering data obtained from other design systems for production.

23. The apparatus as claimed in claim 21, wherein the means for producing the integrated model additionally take into account demands on the control section, and wherein a synthesization means produces a control algorithm for execution in a runtime environment.

24. The apparatus as claimed in claim 22, wherein the means for producing the integrated model additionally take into account demands on the control section, and wherein a synthesization means produces a control algorithm for execution in a runtime environment.

25. The apparatus as claimed in claim 23,
wherein the synthesization means optimizes the control algorithm via syntactic transformations prior to execution.

26. The apparatus as claimed in claim 21, wherein the mathematical model and the integrated model are definable by one of (i) an automaton, (ii) a Petri net and (iii) process algebraic expressions.

27. The apparatus as claimed in claim 21, wherein the means for producing the integrated model of the nominal control section include an interface for inputting further model library elements, and wherein the integrated model is produced by utilizing first model library elements that can be connected up and parameterized, and by utilizing second elements that are input via an interface.

28. A non-transitory computer program product encoded with a computer program executed by a computer that causes automated design of a control loop for regulating a technical process, comprising:
program code for connecting up and parameterizing first model elements of a model library;
program code for defining any faults and effects of said faults occurring in the nominal control section; and
program code for producing, based on a mathematical model and associated fault definitions, an integrated model of a control loop that contains both fault-free and faulty behavior by the control loop.
